(19) United States
(12) Patent Application Publication
(10) Pub. No.: US 2025/0096229 A1
(43) Pub. Date: Mar. 20, 2025

(54) ANODE FOR LITHIUM SECONDARY BATTERY, LITHIUM SECONDARY BATTERY INCLUDING THE SAME AND METHOD OF PREPARING ANODE COMPOSITION FOR LITHIUM SECONDARY BATTERY

(71) Applicant: SK ON CO., LTD., Seoul (KR)

(72) Inventor: So Hyun PARK, Daejeon (KR)

(21) Appl. No.: 18/889,379

(22) Filed: Sep. 19, 2024

(30) Foreign Application Priority Data
Sep. 20, 2023 (KR) 10-2023-0125395

(51) Int. Cl. H01M 4/133; H01M 4/02; H01M 4/587; H01M 4/62; H01M 10/052

(52) U.S. Cl. CPC H01M 4/133; H01M 4/587; H01M 4/62; H01M 10/052; H01M 2004/027

(57) ABSTRACT

An anode for a lithium secondary battery includes an anode current collector, and an anode mixture layer formed on at least one surface of the anode current collector. The anode mixture layer includes mixture materials that includes an anode active material including a silicon-based active material and a carbon-based active material. A binding force between the mixture materials in the anode mixture layer is in a range from 0.335 kN/m to 0.55 kN/m. An adhesion force between the anode current collector and the anode mixture layer is in a range from 5.8 gf/cm to 11 gf/cm.

### CROSS-REFERENCE TO RELATED APPLICATION AND CLAIM OF PRIORITY

This application claims priority to Korean Patent Application No. 10-2023-0125395 filed on Sep. 20, 2023 in the Korean Intellectual Property Office (KIPO), the entire disclosure of which is incorporated by reference herein.

### TECHNICAL FIELD

The disclosure of the present application relates to an anode for a lithium secondary battery, a lithium secondary battery including the same and a method of preparing an anode composition for a lithium secondary battery.

### BACKGROUND

A secondary battery which can be charged and discharged repeatedly has been widely employed as a power source of a mobile electronic device such as a camcorder, a mobile phone, a laptop computer, etc. A lithium secondary battery is being actively developed and applied due to high operational voltage and energy density per unit weight, a high charging rate, a compact dimension, etc.

For example, the lithium secondary battery may include an electrode assembly including a cathode, an anode and a separation layer (separator), and an electrolyte immersing the electrode assembly. The anode may be obtained by coating an anode slurry prepared by mixing and dispersing an anode active material, a conductive material and a binder in a solvent on a current collector.

Recently, as an application range of the lithium secondary battery is expanded, a lithium secondary battery having higher capacity and power has been developed. For example, a silicon-based active material having a higher capacity than that of a carbon-based active material may be used as the anode active material. However, the silicon-based active material has a large volume expansion/contraction ratio during charging and discharging, and may have a large irreversible capacity and a low initial efficiency.

### SUMMARY

According to an aspect of the present disclosure, there is provided an anode for a lithium secondary battery having improved capacity and life-span properties.

According to an aspect of the present invention, there is provided a lithium secondary battery including an anode for a lithium secondary battery with improved capacity and life-span properties.

According to an aspect of the present invention, there is provided a method of preparing an anode composition for a lithium secondary battery having improved coating properties and dispersion stability.

An anode for a lithium secondary battery includes an anode current collector, and an anode mixture layer formed on at least one surface of the anode current collector. The anode mixture layer includes mixture materials that includes an anode active material including a silicon-based active material and a carbon-based active material. A binding force between the mixture materials in the anode mixture layer is in a range from 0.335 kN/m to 0.55 kN/m. An adhesion force between the anode current collector and the anode mixture layer is in a range from 5.8 gf/cm to 11 gf/cm.

In some embodiments, the binding force may be in a range from 0.35 kN/m to 0.45 kN/m.

In some embodiments, the adhesion force may be in a range from 6 gf/cm to 10.5 gf/cm.

In some embodiments, a standard deviation of the adhesion force may be in a range from 0.008 to 0.047.

In some embodiments, the silicon-based active material may include silicon, a silicon oxide (SiOx, 0<x<2), and/or a carbon-silicon composite active material.

In some embodiments, the carbon-based active material may include a graphite-based active material.

In some embodiments, a weight ratio between the silicon-based active material and the carbon-based active material may be in a range from 5:95 to 95:5.

In some embodiments, the weight ratio between the silicon-based active material and the carbon-based active material may be in a range from 40:60 to 60:40.

In some embodiments, the anode mixture layer may be the mixture layer which is formed by coating and drying the anode composition including the mixture materials and an organic acid-based additive on the anode current collector, and the organic acid-based additive may include acetic acid, citric acid, oxalic acid, maleic acid, palmitic acid, tartaric acid, methacrylic acid, glutaric acid and/or fumaric acid.

In some embodiments, a content of the organic acid-based additive may be in a range from 20 wt % to 60 wt % based on the total weight of the anode composition.

In some embodiments, the anode mixture layer may further include a thickener.

In some embodiments, the thickener may include carboxymethyl cellulose.

In some embodiments, the anode mixture layer may further include a conductive material and a binder.

A lithium secondary battery includes the above-described anode for a lithium secondary battery, and a cathode facing the anode.

In a method for preparing an anode composition for a lithium secondary battery, a dispersion including an organic acid-based additive and a silicon-based active material and having a pH in a range from 6 to 12 is prepared. A carbon-based active material and a thickener are mixed into the dispersion.

In some embodiments, the pH of the dispersion may be in a range from 7 to 11.

In some embodiments, the anode composition may be prepared to include 1 part by weight to 100 parts by weight of the organic acid additive relative to 100 parts by weight of the silicon-based active material.

In some embodiments, the anode composition may be prepared to include 30 part by weight to 70 parts by weight of the organic acid additive relative to 100 parts by weight of the silicon-based active material.

In some embodiments, the anode composition may be prepared to include the silicon-based active material and the carbon-based active material in a weight ratio of 5:95 to 95:5.

In some embodiments, the anode composition may be prepared to include the organic acid-based additive in a range of 20 wt % to 60 wt % based on the total weight of the anode composition.

The anode for a lithium secondary battery and the lithium secondary battery including the anode according to example embodiments may have improved capacity and life-span properties.

In a method of preparing an anode composition for a lithium secondary battery, aggregation between anode active materials may be suppressed during a preparation of an anode slurry, and a bonding strength between mixture materials in the anode mixture layer and an adhesive strength between an anode current collector and the anode mixture layer may be enhanced.

The anode and the lithium secondary battery of the present disclosure may be widely applied in green technology fields such as an electric vehicle, a battery charging station, solar power generation wind power generation using other batteries, etc. The anode and the lithium secondary battery according to the present disclosure may be used for eco-friendly electric vehicles and hybrid vehicles to prevent a climate change by suppressing air pollution and greenhouse gas emissions, etc.

### BRIEF DESCRIPTION OF THE DRAWINGS

FIG. 1 is a schematic cross-sectional view illustrating an anode for a lithium secondary battery in accordance with example embodiments.

FIGS. 2 and 3 are a schematic plan view and a schematic cross-sectional view, respectively, illustrating a lithium secondary battery in accordance with example embodiments.

FIG. 4 is an image showing an anode slurry of Example 1.

FIG. 5 is an image showing an anode slurry of Comparative Example 5.

### DETAILED DESCRIPTION OF THE EMBODIMENTS

According to embodiments of the present disclosure, an anode for a lithium secondary battery including an anode mixture layer is provided. Further, a lithium secondary battery including the anode is provided. According to embodiments of the present disclosure, a method of preparing an anode composition for a lithium secondary battery is provided.

Hereinafter, detailed descriptions of the present disclosure will be described in detail with reference to example embodiments and drawings. However, those skilled in the art will appreciate that such embodiments are provided to further understand the spirit of the present inventive concepts do not limit subject matters to be protected as disclosed in the detailed description and appended claims.

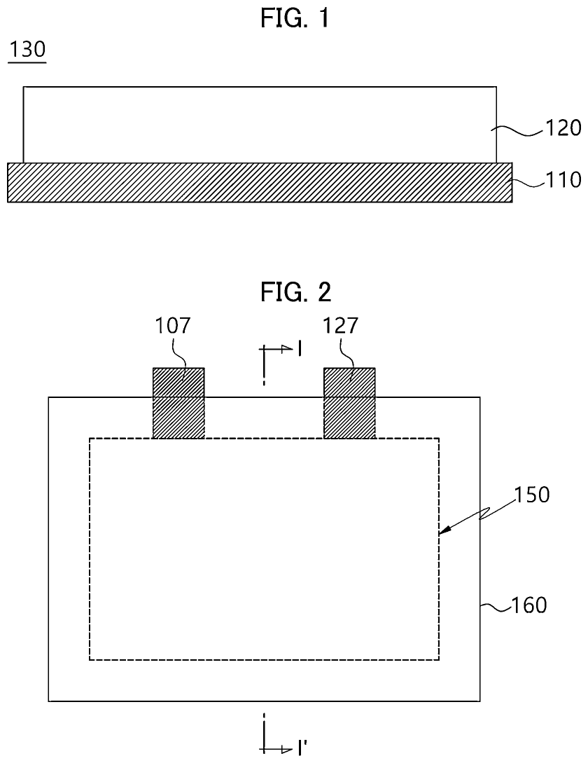

FIG. 1 is a schematic cross-sectional view illustrating an anode for a lithium secondary battery in accordance with example embodiments.

Referring to FIG. 1, an anode 130 may include an anode current collector 125 and an anode mixture layer 120 formed on the anode current collector 125. For convenience of illustration, the anode mixture layer 120 is illustrated as being formed on one surface of the anode current collector 125, but the anode mixture layer 120 may be formed on each of both surfaces (upper and lower surfaces) of the anode current collector 125.

For example, the anode current collector 125 may include a metal having high conductivity and an improved adhesion to an anode slurry, and being non-reactive in a voltage range of a secondary battery. For example, the anode current collector 125 may include copper, stainless steel, nickel, titanium or an alloy thereof. The anode current collector 125 may include copper or stainless steel surface-treated with carbon, nickel, titanium or silver.

In example embodiments, the anode mixture layer 120 including an anode active material including a silicon-based active material and a carbon-based active material may be formed on at least one surface of the anode current collector 125.

The term “carbon-based active material” herein may refer to a carbon-based material that does not include silicon.

In some embodiments, the silicon-based active material may include at least one selected from the group consisting of silicon, silicon oxide (SiOx, 0<x<2), and a carbon-silicon composite active material. The silicon-based active material may provide further increased capacity properties.

In an embodiment, the silicon-based active material may include silicon oxide (SiOx, 0<x<2) and/or the carbon-silicon composite active material.

For example, the carbon-silicon composite active material may include a porous carbon core and a silicon coating formed on the porous carbon core. The porous carbon core may include a carbon-based particle including micropores therein, and the silicon coating may be formed at an inside and/or on a surface of the carbon-based particle.

The carbon-based particle may include an activated carbon, a carbon nanotube, a carbon nanowires, graphene, a carbon fiber, carbon black, graphite, a porous carbon, a pyrolyzed cryogel, a pyrolyzed zero gel, a pyrolyzed aerogel, etc.

The carbon-based particle may include an amorphous structure or a crystalline structure, the silicon coating may have an amorphous structure, and the silicon coating may be formed by a deposition process (e.g., a chemical vapor deposition (CVD) process).

In some embodiments, the carbon-based active material may contain a graphite-based active material.

For example, the carbon-based active material may include at least one selected from the group consisting of artificial graphite, natural graphite, a graphitized coke, a graphitized MCMB (mesocarbon microbeads) and a graphitized MPCF (mesophase pitch-based carbon fiber), and may include artificial graphite and/or natural graphite.

In some embodiments, a weight ratio of the silicon-based active material to the carbon-based active material may be in a range from 5:95 to 95:5.

For example, the weight ratio above may be in a range from 10:90 to 90:10, from 15:85 to 85:15, from 20:80 to 80:20, from 30:70 to 70:30, or from 40:60 to 60:40. In the above range, coating properties and dispersion stability of the anode slurry may be improved when fabricating the anode, and the capacity and life-span properties of the battery may be improved.

In some embodiments, the anode mixture layer 120 may be the mixture layer formed by coating and drying an anode composition which includes the mixture materials and the organic acid-based additive onto the anode current collector 125. The coating and drying process may include, for example, coating the anode composition onto the anode current collector 125 and drying under reduced pressure to form the anode mixture layer 120, or coating the anode composition onto the anode current collector 125 followed by drying and pressing to form the anode mixture layer 120.

In some embodiments, the organic acid-based additive may include at least one selected from the group consisting of acetic acid, citric acid, oxalic acid, maleic acid, palmitic acid, tartaric acid, methacrylic acid, glutaric acid and fumaric acid.

In some embodiments, a content of the organic acid-based additive based on a total weight of the anode composition may be in a range from 20 weight percent (wt %) to 60 wt %.

For example, the content of the organic acid-based additive may be in a range from 25 wt % to 55 wt %, from 30 wt % to 50 wt %, from 20 wt % to 55 wt %, from 25 wt % to 60 wt %, from 30 wt % to 55 wt %, or from 25 wt % to 50 wt %. In the above range, the capacity and life-span properties of the lithium secondary battery may be further improved.

In some embodiments, the anode mixture layer 120 may further include a thickener.

In some embodiments, the thickener may include carboxymethyl cellulose (CMC).

In some embodiments, the anode mixture layer 120 may further include a conductive material and a binder.

For example, the conductive material may include a carbon-based conductive material including natural graphite, artificial graphite, carbon black, acetylene black, Ketjen black, graphene, a carbon nanotube (CNT), a vapor-grown carbon fiber (VGCF), a carbon fiber, and/or a metal-based conductive material including tin, tin oxide, titanium oxide, a perovskite material such as LaSrCoO₃ and LaSrMnO₃, etc.

In an embodiment, the binder may include an acrylic binder and/or a styrene-butadiene rubber (SBR), e.g., may include at least one of polyacrylonitrile, polymethylmethacrylate and styrene-butadiene rubber (SBR).

In some embodiments, a binding force between mixture materials in the anode mixture layer 120 may be in a range from 0.335 kN/m to 0.55 kN/m. The mixture materials may include an anode active material including a silicon-based active material and a carbon-based active material, and an organic acid-based additive, and may further include the binder, the conductive material and the thickener.

For example, the binding force between the mixture materials in the anode mixture layer 120 may be in a range from 0.34 kN/m to 0.54 kN/m, from 0.35 kN/m to 0.53 kN/m, from 0.38 kN/m to 0.52 kN/m, from 0.40 kN/m to 0.52 kN/m, or from 0.45 kN/m to 0.52 kN/m.

When the binding force is less than 0.335 kN/m, the binding force between the anode active materials may be insufficient and an aggregation phenomenon of the anode active materials may occur, thereby deteriorating the life-span properties of the battery. When the binding force exceeds 0.55 kN/m, the binding force between the anode active materials may become, thereby deteriorating processability of the battery.

For example, the binding force can be evaluated by a surface-interface ablation analysis system (SAICAS). When cutting the anode mixture 120 at a depth of 30 μm from a surface using a boron nitride blade (width: 1 mm) under conditions of a horizontal speed of 0.05 μm/s having a shear angle of 45°, a rake angle of 20° and a clearance angle of 10°, a horizontal force (FH) applied to the blade is measured, and a value obtained by dividing the horizontal force (FH) by a blade width can be used as the binding force of the anode mixture 120.

In some embodiments, an adhesion force between the anode current collector 125 and the anode mixture layer 120 may be in a range from 5.8 gf/cm to 11 gf/cm. For example, the adhesion force between the anode current collector 125 and the anode mixture layer 120 may be in a range from 6 gf/cm to 10.9 gf/cm, from 7.5 gf/cm to 10.8 gf/cm, from 8 gf/cm to 10.7 gf/cm, from 9 gf/cm to 10.6 gf/cm, or from 10 gf/cm to 10.5 gf/cm.

When the adhesion force is less than 5.8 gf/cm, electrode detachment and cracks due to volume expansion of the silicon-based active material may not be suppressed, and the life-span properties of the battery may be degraded. When the adhesion force is greater than 11 gf/cm, processability of the battery may be degraded.

For example, the adhesion force may be measured by using an adhesion force measuring apparatus such as MCT-2150. Specifically, a coated anode is attached to an acrylic plate using a 3M double-sided tape. A force when peeling the anode mixture layer from a current collector at an angle of 180° and a speed of 10 mm/see may be used as the adhesion force.

In an embodiment, the binding force between the mixture materials in the anode mixture layer and the adhesion force between the anode current collector and the anode mixture layer maybe adjusted in the above-described ranges, so that high-capacity properties of the silicon-based active material may be sufficiently implemented while suppressing volume expansion/contraction due to charging and discharging. Accordingly, the capacity and life-span of the battery may be improved.

In some embodiments, a standard deviation of the adhesion force between the anode current collector 125 and the anode mixture layer 120 may be in a range from 0.008 to 0.047, from 0.010 to 0.047, from 0.010 to 0.045, from 0.015 to 0.040, from 0.018 to 0.033, or from 0.010 to 0.033.

Within the range of the standard deviation of the adhesion force, uniformity of the electrode may be improved, and processability in the fabrication of a battery may also be improved.

In some embodiments, the anode mixture layer 120 may be formed by coating, drying and pressing an anode composition for a lithium secondary battery that includes the silicon-based active material and the carbon-based active material, and the organic acid-based additive on the anode current collector 125. For example, the composition may be provided in the form of a slurry.

Hereinafter, a method of preparing the anode composition for a lithium secondary battery will be described in more detail.

In example embodiments, a dispersion including the organic acid-based additive and the silicon-based active material and having a pH ranging from 6 to 12 may be prepared. For example, the pH of the dispersion may be in a range from 6.5 to 11.5, from 6.5 to 11, from 6 to 11, from 7 to 12, from 7 to 11.5, or from 7 to 11.

For example, an electrostatic repulsion according to a pH condition may be different for each type of the anode active material, and thus dispersion stability of the anode slurry may be improved by adjusting the pH.

When the pH of the dispersion is less than 6, a phase separation may occur or aggregation between the anode active materials may occur during long-term storage of the anode slurry. When the pH of the dispersion is greater than 12, coating property and dispersibility of the anode composition may be degraded.

In an embodiment, the organic acid-based additive may be added to the silicon active material to achieve the above-described pH condition, and the silicon active material may be dispersed.

For example, the silicon-based active material may include a silicon oxide (SiOx, 0<x<2) or a carbon-silicon composite active material. The dispersion stability of the anode slurry including the silicon-based active material may be improved in the pH range as described above.

For example, the organic acid-based additive may suppress the pH of the anode composition from being excessively increased to form an appropriate range of a viscosity. Thus, the capacity and life-span properties of the lithium secondary battery may be improved.

In some embodiments, a content of the organic acid-based additive may be adjusted according to a concentration of the organic acid and a composition of the silicon-based active material.

For example, the content of the organic acid-based additive may be in a range from 1 part by weight to 100 parts by weight, from 10 parts by weight to 90 parts by weight, from 20 parts by weight to 80 parts by weight, or from 30 parts by weight to 70 parts by weight, relative to 100 parts by weight of the silicon-based active material. In the above range, the pH of the dispersion may be adjusted to an appropriate range, and coating properties and dispersibility of the anode composition may be improved.

For example, the anode composition may be prepared to include the organic acid-based additive in a range of 20 wt % to 60 wt % based on the total weight of the anode composition.

In example embodiments, the carbon-based active material and a thickener may be mixed into the dispersion.

In some embodiments, distilled water may be added, and kneading may be performed to promote the mixing.

For example, when adding the carbon-based active material and the thickener to the dispersion and mixing, the knead may be sufficiently performed while adding distilled. Accordingly, the binding force between the mixture materials in the anode mixture layer and the adhesion force between the anode current collector and the anode mixture layer may be improved.

In some embodiments, the carbon-based active material may be mixed into the dispersion so that a weight ratio between the silicon-based active material and the carbon-based active material is in the range of 5:95 to 95:5 in the anode composition. Thus, the anode composition may be prepared to include the silicon-based active material and the carbon-based active material in a weight ratio of 5:95 to 95:5.

For example, the anode composition may be prepared to include 1 part by weight to 100 parts by weight of the organic acid additive relative to 100 parts by weight of the silicon-based active material.

For example, the anode composition may be prepared to include 30 part by weight to 70 parts by weight of the organic acid additive relative to 100 parts by weight of the silicon-based active material.

In some embodiments, a conductive material and a binder may be added to the dispersion. For example, the conductive material and the binder may be added to the kneaded anode slurry, and the anode composition may be obtained by stirring with a planetary centrifugal mixer.

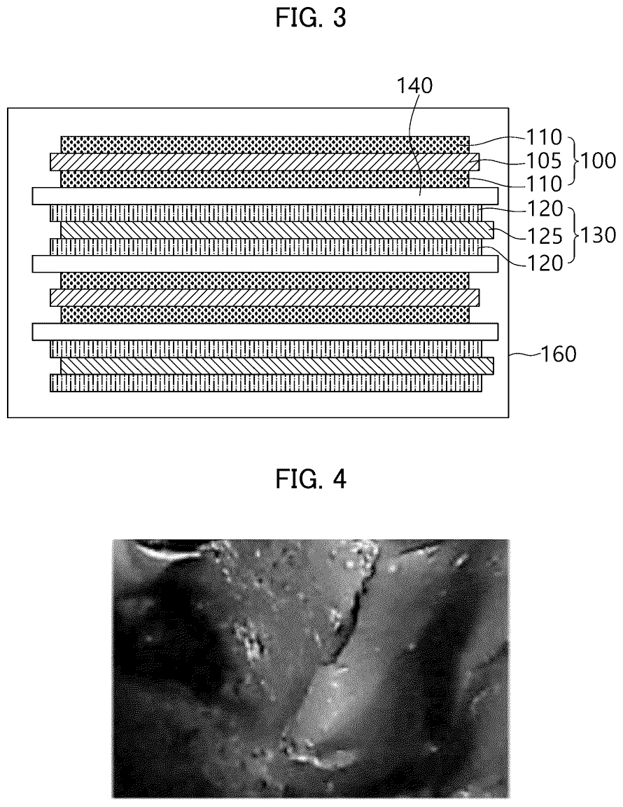

FIGS. 2 and 3 are a schematic plan view and a cross-sectional view, respectively, illustrating a lithium secondary battery in accordance with example embodiments. FIG. 3 is a cross-sectional view taken along a line I-I′ of FIG. 2 in a thickness direction.

Referring to FIGS. 2 and 3, the lithium secondary battery may include an electrode assembly 150 including the above-described anode 130 and a cathode 100 facing the anode 130. The electrode assembly 150 may be accommodated and impregnated with an electrolyte in a case 160.

The cathode 100 may include a cathode mixture layer 110 formed by coating a cathode active material on a cathode current collector 105.

For example, the cathode current collector 105 may include stainless steel, nickel, aluminum, titanium, or an alloy thereof. The cathode current collector may also include aluminum or stainless steel surface-treated with carbon, nickel, titanium or silver. For example, a thickness of the cathode current collector may be in a range from 10 μm to 50 μm.

The cathode active material may include a compound capable of reversibly intercalating and de-intercalating lithium ions.

In example embodiments, the cathode active material may include lithium-nickel metal oxide. For example, the lithium-nickel metal oxide includes nickel (Ni) and may further include at least one of cobalt (Co), manganese (Mn) and aluminum (Al).

For example, the lithium-nickel metal oxide may include a layered structure or a crystal structure represented by Chemical Formula 1 below.

LiₓNiₐM_{b}O_{2+z} [Chemical Formula 1]

In Chemical Formula 1, 0.9≤x≤1.2, 0.6≤a≤0.99, 0.01≤b≤0.4, and −0.5≤z≤0.1. As described above, M may include Co, Mn and/or Al.

The chemical structure represented by Chemical Formula 1 indicates a bonding relationship included in the layered structure or the crystal structure of the cathode active material, and is not intended to exclude another additional element. For example, M includes Co and/or Mn, and Co and/or Mn may serve as main active elements of the cathode active material together with Ni. Chemical Formula 1 is provided to express the bonding relationship of the main active elements, and is to be understood as a formula encompassing introduction and substitution of the additional element.

In an embodiment, an auxiliary element for enhancing chemical stability of the cathode active material or the layered structure/crystal structure may be further included in addition to the main active element. The auxiliary element may be incorporated into the layered structure/crystal structure to form a bond, and it is to be understood that this case is also included within the chemical structure represented by Chemical Formula 1.

The auxiliary element may include at least one of, e.g., Na, Mg, Ca, Y, Ti, Hf, V, Nb, Ta, Cr, Mo, W, Fe, Cu, Ag, Zn, B, Al, Ga, C, Si, Sn, Sr, Ba, Ra, P and Zr. The auxiliary element may act as an auxiliary active element such as Al which may contribute to capacity/power activity of the cathode active material together with Co or Mn.

For example, the cathode active material or the lithium-nickel metal oxide may have a layered structure or a crystal structure represented by Chemical Formula 1-1 below.

LiₓNiₐM1_{b1}M2_{b2}O_{2+z} [Chemical Formula 1-1]

In Chemical Formula 1-1, M1 may include Co, Mn and/or Al. M2 may include the above-described auxiliary element. In Chemical Formula 1-1, 0.9≤x≤1.2, 0.6≤a≤0.99, 0.01≤b1+b2≤0.4, and −0.5≤z<0.1.

The cathode active material may further include a coating element or a doping element. For example, an element substantially the same as or similar to the above-mentioned auxiliary element may be used as the coating element or the doping element. For example, one of the above elements or a combination of two or more therefrom may be used as the coating element or the doping element.

The coating element or the doping element may be present on a surface of the lithium-nickel metal oxide particle or may penetrate through the surface of the lithium-nickel metal oxide particle and be included in the bonding structure represented by Chemical Formula 1 or Chemical Formula 1-1.

The cathode active material may include a nickel-cobalt-manganese (NCM)-based lithium oxide. In this case, an NCM-based lithium oxide having an increased nickel content may be used.

Ni may serve as a transition metal related to power and capacity of a lithium secondary battery. Therefore, as described above, a high-Ni composition may be employed for the cathode active material, so that a high-capacity cathode and a high-capacity lithium secondary battery may be implemented.

However, as the content of Ni increases, long-term storage stability and life-span stability of the cathode or the secondary battery may be relatively deteriorated, and side reactions with the electrolyte may be also increased. However, according to example embodiments, life-span stability and capacity retention may be improved by Mn while maintaining electrical conductivity by the inclusion of Co.

A Ni content (e.g., A mole fraction of nickel among total moles of nickel, cobalt and manganese) in the NCM-based lithium oxide may be 0.6 or more, 0.7 or more, or 0.8 or more. In some embodiments, the Ni content may be from 0.8 to 0.95, from 0.82 to 0.95, from 0.83 to 0.95, from 0.84 to 0.95, from 0.85 to 0.95, or from 0.88 to 0.95.

In some embodiments, the cathode active material may include a lithium cobalt oxide-based active material, a lithium manganese oxide-based active material, a lithium nickel oxide-based active material, or a lithium iron phosphate (LFP) active material (e.g., LiFePO₄).

In some embodiments, the cathode active material may include a Li-rich layered oxide (LLO)/an over lithiated oxide (OLO)-based active material, a Mn-rich-based active material, a Co-less active materials, etc., having, e.g., a chemical structure or a crystal structure represented by Chemical Formula 2.

p[Li₂MnO₃]·(1−p)[Li_{q}JO_{2]} [Chemical Formula 2]

In Chemical Formula 2, 0<p<1, 0.9≤q≤1.2, and J includes at least one element selected from Mn, Ni, Co, Fe, Cr, V, Cu, Zn, Ti, Al, Mg and B.

A cathode mixture may be prepared by mixing and stirring the cathode active material in a solvent. The cathode mixture may be coated on the cathode current collector 105, and then dried and pressed to form the cathode 100. The coating process may include a gravure coating, a slot die coating, a multi-layer simultaneous die coating, an imprinting, a doctor blade coating, a dip coating, a bar coating, a casting, etc., but is not limited thereto. The cathode mixture may further include a binder, and optionally may further include a conductive material, a thickener, etc.

Non-limiting examples of the solvent for preparing the cathode mixture may include N-methyl-2-pyrrolidone (NMP), dimethylformamide, dimethylacetamide, N,N-dimethylaminopropylamine, ethylene oxide, tetrahydrofuran, etc.

The binder may include polyvinylidene fluoride (PVDF), vinylidene fluoride-co-hexafluoropropylene, polyacrylonitrile, polymethylmethacrylate, acrylonitrile-butadiene rubber (NBR), polybutadiene rubber (BR), styrene-butadiene rubber (SBR), etc. In an embodiment, a PVDF-based binder may be used as the cathode binder.

The conductive material may be added to enhance conductivity and/or mobility of lithium ions or electrons of the cathode mixture layer. For example, the conductive material may include a carbon-based conductive material such as graphite, carbon black, acetylene black, ketjen black, graphene, a carbon nanotube, a vapor-grown carbon fiber (VGCF), a carbon fiber, and/or a metal-based conductive material including tin, tin oxide, titanium oxide, a perovskite material such as LaSrCoO₃ or LaSrMnO₃, etc.

For example, carboxymethyl cellulose (CMC) may be used as the thickener.

In some embodiments, the anode 130 may include the anode current collector 125 and the anode mixture layer 120 formed by coating the anode composition on at least one surface of the anode current collector 125, and then drying and pressing the anode composition.

The coating process may include a gravure coating, a slot die coating, a multi-layer simultaneous die coating, an imprinting, a doctor blade coating, a dip coating, a bar coating, a casting, etc., but is not limited thereto.

Non-limiting examples of the anode current collector 125 may include a copper foil, a nickel foil, a stainless steel foil, a titanium foil, a nickel foam, a copper foam, a polymer substrate coated with a conductive metal, etc. A thickness of the anode current collector may be, e.g., in a range from 10 μm to 50 μm.

The anode mixture layer 120 may include an anode active material including the silicon-based active material and the carbon-based active material. In an embodiment, the anode active material may substantially consist of the silicon-based active material and the carbon-based active material.

A separator 140 may be interposed between the cathode 100 and the anode 130. The separator 140 may prevent an electrical short circuit between the cathode 100 and the anode 130 while maintaining a flow of ions. For example, a thickness of the separator 140 may be in a range from 10 μm to 20 μm.

For example, the separator 140 may include a porous polymer film or a porous non-woven fabric. The porous polymer film may include a polyolefin-based polymer such as an ethylene polymer, a propylene polymer, an ethylene/butene copolymer, an ethylene/hexene copolymer, an ethylene/methacrylate copolymer, etc. The porous non-woven fabric may include a high melting point glass fiber, a polyethylene terephthalate fiber, etc.

The separator 140 may include a ceramic-based material. For example, inorganic particles may be coated on the polymer film or dispersed in the polymer film to improve a heat resistance. The separator 140 may have a single-layered or multi-layered structure including the polymer film and/or the non-woven fabric as described above.

In some embodiments, the anode 130 may have larger area (e.g., a contact area with the separator 140) and/or volume than that of the cathode 100. Accordingly, transfer of lithium ions generated from the cathode 100 may be facilitated to the anode 130 without, e.g., being precipitated. Accordingly, the effect of capacity improvement according to the above-mentioned silicon-based active material may be more easily implemented.

In example embodiments, the cathode 100, the anode 130 and the separator 140 may be repeatedly arranged to form an electrode assembly 15. For example, the electrode assembly 150 may have a jellyroll shape formed by winding, stacking, z-folding and stack-folding of the separator 140.

In an embodiment, the electrode assembly 150 may have a jelly roll shape formed by winding the cathode 100, the anode 130 and the separator 140 together. In an embodiment, the electrode assembly 150 may have a jelly roll shape in which notches cathodes and anodes are inserted in spaces formed by repeatedly z-folding the separator 140.

In an embodiment, the cathode 100, the anode 130 and the separator 140 may be repeatedly stacked as a cut or separated layer at each level to form the electrode assembly.

The electrode assembly 150 may be accommodated in a case 190 together with an electrolyte to define a lithium secondary battery. In example embodiments, a non-aqueous electrolyte solution may be used as the electrolyte.

The non-aqueous electrolyte may include a lithium salt and an organic solvent. The lithium salt and may be represented by Li⁺X⁻. An anion of the lithium salt X⁻ may include, e.g., F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, (CF₃CF₂SO₂)₂N⁻, etc.

The organic solvent may include an organic compound having sufficient solubility with respect to the lithium salt and an additive and having substantially no reactivity in the battery. For example, the organic solvent may include at least one of a carbonate-based solvent, an ester-based solvent, an ether-based solvent, a ketone-based solvent, an alcohol-based solvent and/or an aprotic solvent.

The organic solvent may include, e.g., propylene carbonate (PC), ethylene carbonate (EC), butylene carbonate, diethyl carbonate (DEC), dimethyl carbonate (DMC), ethyl methyl carbonate (EMC), methylpropyl carbonate, ethylpropyl carbonate, dipropyl carbonate, vinylene carbonate, methyl acetate (MA), ethyl acetate (EA), n-propylacetate (n-PA), 1,1-dimethylethyl acetate (DMEA), methyl propionate (MP), ethyl propionate (EP), fluoroethyl acetate (FEA), difluoroethyl acetate (DFEA), trifluoroethyl acetate (TFEA), dibutyl ether, tetraethylene glycol dimethyl ether (TEGDME), diethylene glycol dimethyl ether (DEGDME), dimethoxyethane, tetrahydrofuran (THF), 2-methyltetrahydrofuran, ethyl alcohol, isopropyl alcohol, dimethyl sulfoxide, acetonitrile, dimethoxyethane, diethoxyethane, sulfolane, gamma-butyrolactone, propylene sulfite, etc. These may be used alone or in a combination of two or more therefrom.

The non-aqueous electrolyte solution may further include the additive. The additive may include, e.g., a cyclic carbonate-based compound, a fluorine-substituted carbonate-based compound, a sultone-based compound, a cyclic sulfate-based compound, a cyclic sulfite-based compound, a phosphate-based compound and/or a borate-based compound.

The cyclic carbonate-based compound may include vinylene carbonate (VC), vinyl ethylene carbonate (VEC), etc.

The fluorine-substituted cyclic carbonate-based compound may include fluoroethylene carbonate (FEC).

The sultone-based compound may include 1,3-propane sultone, 1,3-propene sultone, 1,4-butane sultone, etc.

The cyclic sulfate-based compound may include 1,2-ethylene sulfate, 1,2-propylene sulfate, etc.

The cyclic sulfite-based compound may include ethylene sulfite, butylene sulfite, etc.

The phosphate-based compound may include lithium difluoro bis-oxalato phosphate, lithium difluorophosphate, etc.

The borate-based compound may include lithium bis(oxalate) borate, etc.

As illustrated in FIG. 2, electrode tabs (a cathode tab and an anode tab) may protrude from the cathode current collector 105 and the anode electrode current collector 125 included in each electrode to one side of the case 160. The electrode tabs may be welded together with the one side of the case 160 to form an electrode lead (a cathode lead 107 and an anode lead 127) extending or exposed to an outside of the case 160.

The lithium secondary battery may be manufactured in, e.g., a cylindrical shape using a can, a prismatic shape, a pouch shape or a coin shape.

Hereinafter, experimental examples are proposed to more concretely describe the present disclosure. However, the following examples are only given for illustrating the present disclosure and those skilled in the related art will obviously understand that various alterations and modifications are possible within the scope and spirit of the present invention. Such alterations and modifications are duly included in the appended claims.

### Example 1

### Fabrication of Anode

A dispersion was prepared by adding 0.1 N acetic acid as an organic acid-based additive to 100 parts by weight of silicon oxide (SiOx, 0<x<2) so that a pH of the dispersion became 7.

20 parts by weight of graphite and 13.3 parts by weight of CMC as a thickener were added to the dispersion, and the mixture was sufficiently kneaded while adding distilled water.

0.1 parts by weight of CNT as a conductive agent, and 6.7 parts by weight of SBR as a binder were added to the above-prepared dough, and stirred using a planetary centrifugal mixer to obtain an anode composition.

The anode composition was coated on a copper foil having a thickness of 100 μm using a doctor blade, and dried under reduced pressure in an oven at a temperature of 120° C. for 4 hours to prepare an anode.

### Fabrication of Lithium Half Cell

A lithium secondary battery including the above-prepared anode was fabricated using a lithium metal as a counter electrode (cathode).

A separator (polyethylene, thickness: 20 μm) was interposed between the above-prepared anode and the lithium metal (thickness: 2 mm) to form a lithium coin half-cell.

An assembly of the lithium metal/separator/anode was placed in a coin cell plate, and a cap was placed and clamped after injecting an electrolyte solution. A 1 M LiPF₆ solution prepared using a mixed solvent EC/FEC/EMC/DEC (20/10/20/50; volume ratio) was used as the electrolyte solution. After the clamping, an immersion was performed for more than 12 hours, and then 3 cycles of charge and discharge were performed at 0.1C (charge conditions: CC-CV 0.1C 0.01V 0.01C CUT-OFF, discharge conditions: CC 0.1C 1.5V CUT-OFF).

### Example 2

An anode and a lithium secondary battery were manufactured by the same method as that in Example 1, except that 60 parts by weight of the carbon-silicon composite active material (SiC) was used instead of 100 parts by weight of the silicon oxide (SiOx, 0<x<2).

### Example 3

An anode and a lithium secondary battery were manufactured by the same method as that in Example 1, except that 0.1N acetic acid was added so that the pH of the dispersion was 11 instead of 7.

### Example 4

An anode and a lithium secondary battery were manufactured by the same method as that in Example 2, except that 0.1 N acetic acid was added so that the pH of the dispersion was 11 instead of 7.

### Comparative Example 1

An anode and a lithium secondary battery were manufactured by the same method as that inn Example 1, except that 0.1 N acetic acid was added so that the pH of the dispersion was 3 instead of 7.

### Comparative Example 2

An anode and a lithium secondary battery were manufactured by the same method as that in in Example 2, except that 0.1 N acetic acid was added so that the pH of the dispersion was 3 instead of 7.

### Comparative Example 3

An anode and a lithium secondary battery were manufactured by the same method as that in in Example 1, except that 0.1 N acetic acid was added so that the pH of the dispersion was 5 instead of 7.

### Comparative Example 4

An anode and a lithium secondary battery were manufactured by the same method as that in Example 2, except that 0.1 N acetic acid was added so that the pH of the dispersion was 5 instead of 7.

### Comparative Example 5

A dispersion was prepared by adding 0.1 N acetic acid as an organic acid additive to 100 parts by weight of a silicon oxide (SiOx, 0<x<2) so that the pH of the dispersion became 11.

20 parts by weight of graphite, 0.1 parts by weight of CNT as a conductive agent, and 6.7 parts by weight of SBR as a binder were added to the dispersion and stirred by a planetary centrifugal mixer to obtain an anode composition.

Thereafter, an anode and a lithium secondary battery including the anode were manufactured by the same method as that in Example 1.

### Comparative Example 6

An anode and a lithium secondary battery were manufactured by the same method as that in Comparative Example 5, except that 60 parts by weight of a carbon-silicon composite active material (SiC) was used instead of 100 parts by weight of the silicon oxide (SiOx, 0<x<2).

### Experimental Example

### (1) Evaluation on Appearance of Anode Slurry

Appearances of the anode composition (slurry) manufactured according to Example 1 and Comparative Example 5 were observed with naked eyes.

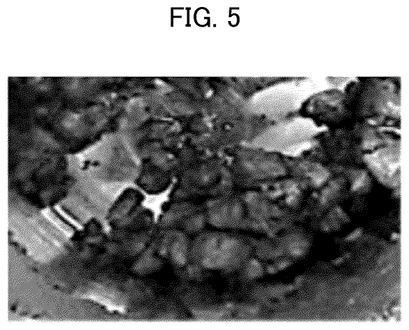

FIG. 4 is an image showing the anode slurry of Example 1. FIG. 5 is an image showing the anode slurry of Comparative Example 5.

Referring to FIGS. 4 and 5, the anode slurry of Example 1 in which THE thickener was added to the dispersion and sufficiently kneaded showed an enhanced appearance. However, the anode slurry of Comparative Example 5 in which the thickener was not added to the dispersion without kneading showed a degraded appearance.

### (2) Evaluation on Storage Stability

The anode compositions manufactured according to Examples and Comparative Examples were transferred to a 50 mL vial and left at room temperature (25° C.) for 15 days. Thereafter, a change in the anode composition (whether a phase separation occurred) was confirmed

### <Evaluation Criteria>

O: The anode composition was completely separated into solid and liquid phases

Δ: Some of solids in the anode composition were sedimented

x: The phase separation did not occurred.

### (3) Evaluation on Coating Property

A surface coatability of each anode manufactured according to Examples and Comparative Examples was visually evaluated.

The case in which impurities or agglomeration generated was evaluated as “good.” The case in which impurities or agglomeration was evaluated as “poor.”

### (4) Evaluation on Binding Force Between Mixture Materials in the Anode Mixture Layer

For the anodes manufactured according to Examples and Comparative Examples, binding properties of the anode mixture layer were analyzed using a Surface And Interfacial Cutting Analysis System (SAICAS).

A horizontal force (FH) applied to a blade when cutting the anode mixture layer at a depth of 30 μm from a surface and at a horizontal speed of 0.05 μm/s, was measured using a boron nitride blade (width: 1 mm) with a shear angle of 45°, a rake angle of 20° and a clearance angle of 10°. The value obtained by dividing the horizontal force by the width of the blade was used as a binding force of the anode mixture layer.

### (5) Evaluation of the Adhesion Force Between Anode Current Collector and Anode Mixture Layer

Each anode of Examples and Comparative Examples was cut into a size of a width of 25 mm and a length of 40 mm, and attached to a 3M 810 scotch tape. Both surfaces of the anode and the scotch tape were clamped and fixed, and a force when the anode mixture layer was peeled from a copper foil (current collector) at an angle of 180° and a constant speed of 10 mm/min was measured as an adhesion force by using a universal testing machine (UTM, MCT-2150, A&D Company, Japan). A standard deviation of the adhesion force was also calculated.

### (6) Evaluation on Life-Span Property

The lithium secondary batteries manufactured according to Examples and Comparative Examples were charged at 0.3 C to a voltage corresponding to an SOC96 under constant current/constant voltage (CC/CV) conditions at 25° C. and 0.05C cut off, discharged at 0.5 C to a voltage corresponding to an SOC2 under a constant current (CC) condition, and then a discharge capacity was measured.

The above cycle was repeated 500 times. A discharge capacity after the 500th cycle was calculated as a ratio (%) relative to the discharge capacity after the first cycle to measure a capacity retention.

The results are shown in Table 1 below.

TABLE 1

| | | | binding | adhesion | standard | capacity |
|---|---|---|---|---|---|---|
| | phase | coating | force | force | deviation of | retention |
| | separation | property | (kN/m) | (gf/cm) | adhesion force | (500 cycles, %) |
| Example 1 | X | good | 0.389 | 8.7 | 0.033 | 87.1 |
| Example 2 | Δ | good | 0.338 | 5.8 | 0.047 | 86.8 |
| Example 3 | X | good | 0.512 | 10.5 | 0.010 | 93.2 |
| Example 4 | X | good | 0.448 | 9.8 | 0.018 | 90.1 |
| Comparative Example 1 | Δ | good | 0.313 | 5.2 | 0.055 | 80.4 |
| Comparative Example 2 | Δ | poor | 0.277 | 4.5 | 0.068 | 79.8 |
| Comparative Example 3 | Δ | good | 0.317 | 5.5 | 0.051 | 83.3 |
| Comparative Example 4 | Δ | good | 0.314 | 5.3 | 0.052 | 81.5 |
| Comparative Example 5 | X | good | 0.332 | 5.7 | 0.049 | 85.6 |
| Comparative Example 6 | ◯ | poor | 0.253 | 3.7 | 0.100 | 77.3 |

Referring to Table 1, the anode compositions of Examples had improved storage stability and dispersibility. The coating property, the binding force between the mixture materials in the anode mixture layer, and the adhesion force between the anode current collector and the anode mixture layer were increased. Additionally, the capacity retention was increased in the batteries of Examples.

However, in the anode compositions of Comparative Examples 1 and 2 prepared from the dispersion of pH 3, the anode compositions of Comparative Examples 3 and 4 prepared from the dispersion of pH 5, and the anode compositions of Comparative Example 6 prepared without sufficient kneading and without using the thickener were phase-separated or agglomerated when manufacturing the anode.

In the anodes of Comparative examples, the binding force between the mixture materials in the anode mixture layer and the adhesion force between the anode current collector and the anode mixture layer were lowed. Further, the capacity retention was also reduced in the lithium secondary battery of Comparative Examples.

What is claimed is:

1. An anode for a lithium secondary battery, comprising:
an anode current collector; and
an anode mixture layer formed on at least one surface of the anode current collector, the anode mixture layer comprising mixture materials that includes an anode active material including a silicon-based active material and a carbon-based active material, and
wherein a binding force between the mixture materials in the anode mixture layer is in a range from 0.335 kN/m to 0.55 kN/m, and
an adhesion force between the anode current collector and the anode mixture layer is in a range from 5.8 gf/cm to 11 gf/cm.

2. The anode for a lithium secondary battery according to claim 1, wherein the binding force is in a range from 0.35 kN/m to 0.45 kN/m.

3. The anode for a lithium secondary battery according to claim 1, wherein the adhesion force is in a range from 6 gf/cm to 10.5 gf/cm.

4. The anode for a lithium secondary battery according to claim 1, wherein a standard deviation of the adhesion force is in a range from 0.008 to 0.047.

5. The anode for a lithium secondary battery according to claim 1, wherein the silicon-based active material includes at least one selected from the group consisting of silicon, a silicon oxide (SiOx, 0<x<2), and a carbon-silicon composite active material.

6. The anode for a lithium secondary battery according to claim 1, wherein the carbon-based active material includes a graphite-based active material.

7. The anode for a lithium secondary battery according to claim 1, wherein a weight ratio between the silicon-based active material and the carbon-based active material is in a range from 5:95 to 95:5.

8. The anode for a lithium secondary battery according to claim 1, wherein a weight ratio between the silicon-based active material and the carbon-based active material is in a range from 40:60 to 60:40.

9. The anode for a lithium secondary battery according to claim 1, wherein the anode mixture layer is the mixture layer formed by coating and drying the anode composition including the mixture materials and an organic acid-based additive on the anode current collector, and the organic acid-based additive includes at least one selected from the group consisting of acetic acid, citric acid, oxalic acid, maleic acid, palmitic acid, tartaric acid, methacrylic acid, glutaric acid and fumaric acid.

10. The anode for a lithium secondary battery according to claim 9, wherein a content of the organic acid-based additive is in a range from 20 wt % to 60 wt % based on the total weight of the anode composition.

11. The anode for a lithium secondary battery according to claim 1, wherein the anode mixture layer further includes a thickener.

12. The anode for a lithium secondary battery according to claim 9, wherein the thickener includes carboxymethyl cellulose.

13. The anode for a lithium secondary battery according to claim 1, wherein the anode mixture layer further includes a conductive material and a binder.

14. A lithium secondary battery, comprising:
an anode for a lithium secondary battery according to claim 1; and
a cathode facing the anode.

15. A method for preparing an anode composition for a lithium secondary battery, comprising:
preparing a dispersion including an organic acid-based additive and a silicon-based active material and having a pH in a range from 6 to 12; and
mixing a carbon-based active material and a thickener into the dispersion.

16. The method according to claim 15, wherein the pH of the dispersion is in a range from 7 to 11.

17. The method according to claim 15, wherein the dispersion is prepared to include 1 part by weight to 100 parts by weight of the organic acid additive relative to 100 parts by weight of the silicon-based active material.

18. The method according to claim 17, wherein the dispersion is prepared to include 30 part by weight to 70 parts by weight of the organic acid additive relative to 100 parts by weight of the silicon-based active material.

19. The method according to claim 15, wherein mixing the carbon-based active material into the dispersion so that a weight ratio between the silicon-based active material and the carbon-based active material is in the range of 5:95 to 95:5.

20. The method according to claim 15, wherein the anode composition is prepared to include the organic acid-based additive in a range of 20 wt % to 60 wt % based on the total weight of the anode composition.
